(19) United States
(12) Patent Application Publication
(10) Pub. No.: US 2025/0034020 A1
(43) Pub. Date: Jan. 30, 2025

(54) HYBRID GLASS-MANUFACTURING FURNACE WITH THREE CONVECTION CURRENTS FOR FEEDING A FLOAT UNIT

(71) Applicant: SAINT-GOBAIN GLASS FRANCE, COURBEVOIE (FR)

(72) Inventors: Aurélien SAGET, COURBEVOIE (FR); Philippe DE DIANOUS, COURBEVOIE (FR); Arnaud LE VERGE, COURBEVOIE (FR); Jean-Marie COMBES, COURBEVOIE (FR)

(21) Appl. No.: 18/714,124

(22) PCT Filed: Nov. 18, 2022
(86) PCT No.: PCT/EP2022/082517

§ 371 Date: May 29, 2024

(30) Foreign Application Priority Data
Nov. 30, 2021 (EP) 21306665.7
Jun. 13, 2022 (EP) 22305860.3

(51) Int. Cl. C03B 5/185; C03B 5/03; C03B 5/182; C03B 5/23

(52) U.S. Cl. CPC C03B 5/185; C03B 5/03; C03B 5/182; C03B 5/23

(57) ABSTRACT

A glass-manufacturing furnace for feeding a float unit for floating glass on a bath of molten metal, the furnace including, from upstream to downstream: a hot-crown melting zone including burners to melt a glass batch to obtain a glass bath, the melting zone including a first convection current and delimited by a no-return separation device to prevent the molten glass from going back into the melting zone; a glass-refining zone including a first refining zone including a burner and electrodes and a second refining zone, the first refining zone being separated from the melting zone by the separation device and from the second refining zone by a wall, respectively, wherein the glass is recirculated in the first refining zone on a second convection current and in the second refining zone on a third convection current; and a glass-cooling zone including a conditioning tank through which the third convection current flows.

### TECHNICAL FIELD OF THE INVENTION

The invention relates to a hybrid glass-manufacturing furnace with three convection currents for feeding a float unit.

The invention relates more particularly to a hybrid furnace for the manufacture of glass that further brings together a fuel-fired melting zone, equipped with burners and advantageously supplemented with (“boosted” by) electrical heating means, and a refining zone comprising a first refining zone which is configured so as to be able to control the temperature of the glass therein independently of those of a melting zone located upstream and a second refining zone located downstream.

The invention also relates to a method for manufacturing glass in such a hybrid furnace for glass manufacturing.

The method and the hybrid glass-manufacturing furnace according to the invention is not only able to provide a high-quality glass having less than 0.1 bubble per liter, it is also able to provide such a glass with a load of at least 400 tons per day in order to feed a float unit for floating glass on a bath of molten metal intended to manufacture flat glass.

### TECHNICAL BACKGROUND

Different examples of furnace designs for the manufacture of glass that depend in particular on the product to be manufactured, i.e. on the final shaping of the glass, are known from the prior art.

Thus, a distinction is made between different furnace designs depending on whether the envisaged production relates to glass fibers, industrial hollow glass forming or even flat glass forming.

One of the industrial challenges in the design of glass furnaces is being able to obtain glass for which the quality requirements depend on the product; in this respect, the production of flat glass is comparatively one of the most demanding.

Produced in very large amounts, flat glass is used in numerous applications due to its versatile character, being in particular widely used in the sectors of electronics (flat screens) or else the construction and automotive industries, in which this glass can be transformed using to a wide variety of techniques (bending, tempering, etc.), thus constituting a base glass for a whole range of glass products.

Addressing proportionally the challenges regarding both quality and quantity, the present invention therefore targets glass manufacturing for the industrial forming of such a flat glass, which glass is conventionally obtained by means of a float unit for floating glass on a bath of molten metal, generally tin; this floating method is why such flat glass is referred to as “float” glass.

For the manufacture of flat glass with a float unit, the glass is expected to be able to marry both quality and quantity.

On the one hand, it is expected to be able to continuously supply the float unit or “float” with a large amount of glass, i.e. with a load generally of greater than 400 tons per day, advantageously greater than 600 tons per day, or even 1000 tons per day or more, which is comparatively much greater than that required for manufacturing glass fibers or industrial hollow glass forming.

On the other hand, it is expected to be able to feed the float unit or “float” with high-quality glass, that is to say glass containing as few unmelted materials or bubbles as possible, i.e. generally glass having less than 0.5 bubble/liter.

Indeed, the quality of the glass is in particular, but not exclusively, determined on the basis of the number of bubble(s) present in the glass, which is expressed as “bubble per liter”. Thus, the quality of a glass is considered all the higher when the number of bubble(s) per liter present in the glass is particularly low, or even minuscule.

Moreover, it is recalled that the presence of bubbles (or gaseous defects) in the glass is inherent to the method for manufacturing the glass in the glass-making process in which a distinction is generally made between three successive steps or phases: melting; refining and homogenization; and the thermal conditioning of the glass.

Indeed, the presence of bubbles in the glass results from the melting step during which a glass batch, also referred to as “composition”, is melted. The glass batch consists of raw materials comprising, for example, a mixture of sand, limestone (calcium carbonate), sodium carbonate, dolomite for the manufacture of soda-lime glass (the glass most commonly used for the manufacture of flat glass), to which is advantageously added cullet consisting of glass debris in order in particular to promote melting.

The glass batch is transformed into a liquid mass in which even the least miscible particles dissolve, i.e. the particles most rich in silicon dioxide or silica (SiO₂) and with low quantities of sodium oxide (Na₂O).

Sodium carbonate (Na₂CO₃) begins to react with the grains of sand from 775° C., thereby releasing carbon dioxide bubbles (CO₂) into a liquid that is becoming increasingly viscous as the carbonate is transformed into silicate. Likewise, the transformation of the limestone grains into lime and the decomposition of the dolomite also cause the emission of carbon dioxide (CO₂).

The melting step is complete when there are no more solid particles in the molten glass liquid, which has become very viscous but which, at this stage of the manufacturing method, is then filled with air and gas bubbles.

The refining and homogenization step, generally referred to as refining, then makes it possible to eliminate said bubbles present in the molten glass.

In a known manner, “fining agents” are advantageously used during this step, i.e. substances at a low concentration which, by decomposing at the melting point of the bath, provide gases which cause the bubbles to grow larger, in order to accelerate their rise toward the surface of the glass.

The step of thermal conditioning of the manufacturing method then makes it possible to lower the temperature of the glass as soon as, at the start of the shaping operation, the viscosity of the glass must generally be at least ten times higher than during refining.

There is of course a correspondence between each of the steps of manufacturing the glass that have just been described and the structure of a furnace intended for implementing these steps.

Generally, such a furnace for manufacturing glass thus comprises, in succession, a melting zone in which the transformation by melting of the glass batch into a glass bath takes place, then a refining and homogenization zone in order to remove the bubbles from the glass, and finally a thermal conditioning zone used to cool the glass so as to bring it to the forming temperature, which is much lower than the temperatures experienced by the glass during its production.

What is particularly worth retaining from the glass-making process that has just been recalled is that the step of melting is accompanied by the emission of carbon dioxide (CO₂), i.e. one of the main greenhouse gases implicated in climate change.

Apart from manufacturing high-quality glass and the industrial challenges of high productivity with the lowest possible costs of construction and furnace operation, one of the other major challenges which the glass industry must tackle is currently ecological, namely the need to find solutions to reduce the carbon footprint (or CO₂ footprint) associated with the glass-making process.

To reach the goal of carbon neutrality, a global approach of the process is favored, aiming to act at multiple points to reduce both direct emissions during manufacture and indirect emissions, or emissions upstream and downstream in the value chain, for example those associated with the transport of the materials upstream and then the product downstream.

Thus, these multiple points include the design of the products and the composition of the materials, improving the energy efficiency of industrial processes, using renewable and decarbonized energy, collaborating with raw materials suppliers and logistics companies in order to reduce their emissions, and finally exploring technologies for capturing and sequestering residual emissions.

In direct emissions, besides those inherent in the glass-making process recalled above, the type of energy used most particularly for the high-temperature (more than 1500° C.) melting step represents the largest contribution to the carbon footprint in the glass-making process, since it is generally a fossil energy, most often natural gas, or even petroleum products such as fuel oil.

Therefore, the search for new furnace designs must not only make it possible to respond to industrial challenges related to the quality of the glass and a suitable quantity, but also make it possible to reduce the carbon footprint of the glass-making process, in terms of both direct and indirect carbon dioxide (CO₂) emissions, by reducing in particular the use of fossil energy.

Glass is manufactured in furnaces which have not stopped evolving since the first pot (or crucible) furnaces, through the Siemens furnace, which is usually considered to be the forerunner of the modern-day large continuous-cast glass furnaces, like cross-fired furnaces which can produce up to 1200 tons of float glass per day.

The choice of energy used for melting thus leads to a distinction being made principally between two large furnace designs for the manufacture of glass; fuel-fired furnaces and electric furnaces.

According to the first design, fuel-fired furnaces generally use fossil fuels, in particular natural gas for the burners; thermal energy is thus transmitted to the glass by heat exchange between the flames and the surface of the glass bath.

The above-mentioned cross-fired furnaces are an example of a furnace according to this first design, and are widely used to feed molten glass to a float unit or “float” intended to manufacture flat glass.

According to the second design, electric furnaces are furnaces in which thermal energy is produced by the Joule effect in the mass of the molten glass.

Indeed, glass is an insulating substance at room temperature and becomes electrically conductive at high temperature, so that it is possible to envisage using the Joule effect within the glass melts themselves in order to heat them.

However, electric furnaces are, for example, used for the production of specific glass types such as fluoride opal glass or lead crystal or else are commonly used for the manufacture of glass fibers for thermal insulation.

Thus, it is commonly acknowledged by a person skilled in the art that such electric furnaces are not able to feed, either in terms of quantity or above all in terms of quality of glass (as a reminder, less than 0.5 bubble per liter), a float unit for floating glass on a bath of molten metal intended for the manufacture of flat glass.

This is why fuel-fired furnaces (such as cross-fired furnaces) remain to this day the only furnaces capable of feeding such a float glass unit.

Furthermore, fuel-fired furnaces have various advantages which justify their wide-ranging use in glass-making.

However, fuel-fired furnaces rely on the use of fossil energy, essentially natural gas for the fuel, and therefore their carbon footprint is relatively incompatible with the goals of reducing of carbon dioxide (CO₂) emissions, i.e. the carbon footprint of the glass-making process.

In order to supplement the disclosure of furnace designs for manufacturing glass according to the prior art, mention will also be made of a “third design” or evolution of the furnace, having recently undergone improvements in order to tackle in particular the ecological issue of reducing carbon dioxide (CO₂) emissions.

This third furnace design is based on a fuel-fired furnace, however it uses supplementary electrical heating, in particular in order to momentarily increase the production of the furnace or else to improve the quality of the glass.

Therefore, such furnaces are also called “fuel-fired furnaces with electrical supplement”.

The furnaces according to this third design thus combine a plurality of sources of energy, respectively fossil and electrical, and are therefore also referred to as “hybrid” furnaces.

Adding supplementary electrical heating makes it possible to improve the melting capacity of fuel-fired furnaces which is limited by the heat transfer occurring between the flame and the surface of the glass bath.

However, the operation of such a hybrid furnace is always predominantly based on the use of a fossil fuel, typically gas, and therefore the impact ultimately obtained on improving the carbon footprint of the glass-making process remains limited.

Indeed, electricity is used here only as a supplement, and therefore its impact is proportional, i.e. limited, generally not contributing more than 15% to the heat supply required for the melting step.

In addition, to improve the carbon footprint, the electricity used must also be what is referred to as “green” electricity, i.e. electricity produced from renewable and decarbonized sources of energy.

The invention aims in particular to propose a novel design of furnace for the manufacture of glass, as well as a manufacturing method, capable of providing high-quality glass for feeding a float glass unit intended to manufacture flat glass, all while having energy consumption which makes it possible to obtain a significant reduction in the carbon dioxide (CO₂) emissions associated with the glass-making process.

### SUMMARY OF THE INVENTION

To this end, the invention relates to a hybrid glass-manufacturing furnace for feeding a float unit for floating glass on a bath of molten metal, said hybrid furnace comprising, from upstream to downstream:
a hot-crown melting zone comprising at least some burners that are able to melt a glass batch to obtain a glass bath, said melting zone comprising a first convection current and being delimited by a “no-return” separation device that is configured to prevent the molten glass from going back into the melting zone;
a glass-refining zone comprising a first refining zone comprising at least one burner and electrodes and a second refining zone, said first refining zone being separated from the melting zone by said separation device and from the second refining zone by a wall, respectively, wherein the glass is recirculated in the first refining zone on a second convection current and in the second refining zone on a third convection current; and
a glass-cooling zone comprising a conditioning tank through which said third convection current flows.

Advantageously, the hybrid furnace is able to feed a float unit for floating glass on a bath of molten metal with a load of greater than or equal to 400 tons per day, preferentially between 600 and 900 tons per day, or even 1000 tons per day or more, with high-quality glass.

The furnace according to the invention is said to be “hybrid” by analogy with the third furnace design described above; the term “hybrid” is thus used to describe it because of the use of two different energy sources: fuel energy and electrical energy, respectively.

However, the analogy with the present invention does not go beyond that, because the electrical energy is not only advantageously used as a supplement for the melting step but also, and especially, is mainly used during a refining step carried out separately from the melting step, such that the contribution made by the electrical energy in the entire production process is substantial compared to the prior art.

Indeed, the invention advantageously proposes a level of hybridization that is much greater than has been known to date in the prior art, since the contribution made by electrical energy in the provision of heat by all the electrodes arranged in the first refining zone, or even as a supplement in the melting zone and in the second refining zone, amounts to at least 40% and even more of the total heat provided to the furnace.

Advantageously, the hybrid furnace according to the invention therefore partly relies on electrical energy by banking on the increasing availability of “green” electricity, for example obtained from wind energy, solar energy, etc., and not from fossil fuels such as coal or oil.

Advantageously, the fuel energy used in the burners of the melting zone is not fossil energy such as natural gas, but another equivalent fuel energy, preferentially hydrogen, as a variant of biomethane.

The hybrid furnace according to the invention therefore combines a fuel-fired melting zone with an electrical supplement, and a preferentially electrical refining zone with supplementary fuel-firing, comprising a first refining zone and a respectively separated second refining zone.

By virtue of such a combination, the hybrid furnace according to the invention makes it possible to obtain high-quality glass, i.e. glass comprising less than 0.1 bubble per liter, such that this glass is advantageously capable of supplying a float glass unit or “float” intended for the manufacture of flat glass.

Indeed, the hybrid furnace according to the invention proposes a novel design which is based on a separation of the zones obtained upstream by means of a separation device such as a wall or a barrier in a neck and/or a raised portion of the bottom of the neck and, downstream, another wall in order to consequently separate the steps of the manufacturing method which are respectively implemented therein.

By virtue of this separation, it therefore becomes possible to control each of the steps of the method independently of the others and in so doing to optimize most particularly the energy consumption of each, which is beneficial in particular for the carbon footprint.

Advantageously, in particular, the molten glass does not go back from the refining zone to the melting zone in a hybrid furnace according to the invention. Thus, no convection current or glass recirculation loop extends from the refining zone to the melting zone, as in a furnace according to the prior art in which a first current in the melting zone and a second current in the refining zone mutually exchange the glass.

In the prior art, and unlike in the present invention, the supply of heat does not serve separately for the melting step or for the refining step, in the absence of separate areas with independent currents.

Indeed, part of the heat supplied for example in the refining zone of a hybrid furnace according to the prior art is generally driven upstream by the first current in the melting zone, such that it is only possible to control the manufacturing method as a whole without being able to precisely and independently control each of the various steps of melting, refining and cooling.

In a furnace according to the invention, the step of refining the glass is carried out on glass which advantageously contains little or no unmelted material by virtue in particular of the “no-return” separation device, such as at least a first wall or else a neck with a raised portion of the bottom and/or a barrier, making it possible to increase the residence time of the glass in the melting zone.

In the present invention, high-quality glass is in particular obtained by virtue of a refining zone which is capable of being controlled separately, independently from the melting zone, by virtue of which it is possible to dissociate the thermal regime from each of these zones.

In a furnace according to the prior art, in the absence of separation and independent convection currents, such a dissociation of the thermal regimes is not possible. Thus, it is not possible to finely optimize the heat supply separately for the melting step and for the refining step, in particular.

In the invention, each of the three convection currents contained in the melting zone, the first refining zone and the second refining zone of the refining zone, respectively, is controlled separately.

Advantageously, the use of a fuel energy mainly for the melting step, preferentially supplemented by electrical energy, makes it possible to more effectively melt the glass batch at a temperature which is in particular lower than electrical melting would require by comparison, and therefore the choice of melting by combustion is also beneficial in terms of the lifetime of the furnace.

Advantageously, the electrical energy used for the electrodes of the first refining zone is transformed into a heat supply which is only used in the refining and is in particular not transmitted to the melting zone by virtue of the (no-return) separation device not allowing it to go back to said melting zone; the first convection current and the second convection current of the glass are thus independent from each other.

Advantageously, the hybrid furnace according to the invention forms a duel compromise based, on the one hand, on a substitution of fossil energy as fuel and, on the other hand, on the increasing availability of “green” electricity, for example obtained from wind energy, solar energy, etc.

Advantageously, the fuel energy used in the burners of the melting and refining zones is not fossil energy such as natural gas, but another equivalent fuel energy, preferentially hydrogen, as a variant of biomethane.

The hybrid furnace according to the invention is therefore capable of responding not only to the issue of quantity and high quality of glass required for feeding a float unit or “float”, but also to the ecological issue in order to allow a substantial reduction in the carbon footprint of the production process.

In a preferred embodiment, the hybrid furnace comprises a neck, referred to as first neck, which connects the melting zone to the refining zone.

Advantageously, the first neck of the hybrid furnace contributes, in combination with the separation device, to controlling the temperature of the glass by making it possible to ensure cooling of the glass which flows from the melting zone to the glass refining zone, by virtue of which the first convection current and the second convection current are controlled, ultimately to the benefit of manufacturing a desired amount of high-quality glass.

Advantageously, the hybrid furnace comprises means for cooling the glass which are able to selectively cool the glass in the first neck.

Advantageously, the means for cooling the glass are able to ensure variable, that is to say adjustable, cooling, in particular determined on the basis of the temperature of the glass. Preferably, the hybrid furnace comprises an air-circulation cooling device forming all or part of said means for cooling the glass.

Advantageously, the means for cooling the glass are able to ensure variable, that is to say adjustable, cooling, in particular determined on the basis of the temperature of the glass.

Advantageously, high-quality glass is in particular obtained by virtue of the refining step which is carried out after the melting step, said refining step being further controlled by virtue of the cooling of the glass in the first neck, which cooling contributes to obtaining the two convection currents, to controlling the guidance of the glass.

Advantageously, the high-quality glass is also obtained by virtue of the separation device which, arranged in the first neck of the hybrid furnace, is configured so that the molten glass does not go back from the refining zone to the melting zone. By virtue of the separation device, the flow of the glass in the first neck is a “piston”-type flow.

The separation device limits the amount of molten glass flowing downstream from the melting zone, thus promoting cooling of the glass in the first neck; this is why there is synergy between the separation device and the first neck.

Furthermore, the separation device also prevents the glass from going back into the first neck, from the refining and homogenization zone to the melting zone, by virtue of which the molten glass is capable of being cooled in the first neck and then refined in the refining and homogenization zone comprising a first convection current and a second convection current.

Advantageously, the separation device is formed by a barrier and/or a raised portion of the bottom of the first neck which are able, respectively alone or together, to prevent the molten glass from going back from the refining zone to the melting zone of the hybrid furnace according to the invention.

Compared to a hybrid furnace according to the invention, a furnace comprising a submerged throat connecting a melting zone to a refining zone is not able to ensure such a function of preventing the glass from returning.

Indeed, a return current of the glass exists in such a throat, in particular due to the wear of the materials.

In addition, the glass flowing in a throat is not in contact with the atmosphere, and therefore it is not likely to be cooled on the surface, in particular but not exclusively as in the first neck which advantageously comprises means for cooling the glass such as an air-circulation cooling device.

Furthermore, a throat has a section limited by construction and therefore, unlike a hybrid furnace according to the invention preferentially comprising a first neck, a load to feed a float unit cannot be obtained.

The hybrid furnace according to the present invention consists of a combination of features and not a juxtaposition as soon as there are interactions between the technical features, a synergy, in particular between the melting zone comprising the first convection current and the refining zone comprising the second and third convection current.

In the preferred embodiment, the first neck and the associated separation device are respectively able to allow cooling of the glass and to prevent the glass from going back to the melting zone.

By virtue of said first neck and of the separating device, the temperature of the glass is capable of being controlled separately and precisely in the melting zone on the one hand and in the refining zone on the other hand.

Preferably, the length of the first neck is configured to obtain cooling, lowering the temperature of the glass. Indeed, the molten glass obtained with electrical melting as a supplement generally has higher temperatures, in particular compared to only fuel-fired melting.

By way of example, the temperature of the glass in the melting zone is approximately 1450° C. when the temperature desired for the glass in the downstream part of the first neck is rather of the order of 1300° C. to 1350° C.

Advantageously, the hybrid furnace comprises means for cooling the glass arranged in the first neck so as to selectively cool the glass, i.e. to control the cooling in order to actively regulate the temperature of the glass.

Preferably, the cooling means are formed by at least one air-circulation cooling device, the air being introduced into the atmosphere of the first neck so as to come into contact with the surface of the glass bath and being extracted in order to discharge the heat (calories) transmitted to the air by the glass.

According to another exemplary embodiment, the cooling means are submerged in the glass flowing from upstream to downstream through the first neck in order to enable cooling thereof.

Such cooling means submerged in the glass are for example formed by the barrier which, forming all or part of the separation device, is cooled by a cooling circuit containing heat-transfer fluid, in particular a circuit of the “water jacket” type.

According to another example, the cooling means are formed by vertical studs arranged in the first neck and submerged in the glass which are cooled by a cooling circuit containing heat-transfer fluid in order to discharge the heat transmitted by the glass.

According to yet another exemplary embodiment, the cooling means are able to cool the structure of the first neck in contact with the glass, the cooling being carried out from the outside of the structure of the first neck.

Of course, the cooling means associated with the first neck according to the various examples that have just been given can be implemented alone or in combination.

Advantageously, the means for cooling the glass associated with the first neck make it possible to selectively control the temperature of the glass, which temperature is likely to vary, in particular when the load varies; this is because an increase in the load causes an increase in the temperature of the glass.

By comparison with such means for cooling the glass associated with the first neck, such a variable cooling of the glass would not be possible with a throat.

According to other features of the furnace according to the invention:
the separation device is able to prevent the glass from going back from the first refining zone to the melting zone, as a result of which the first convection current of the melting zone is able to be controlled independently of the second convection current of the first refining zone;
the separation device is configured to limit the amount of glass passing from the melting zone to the first refining zone so as to increase the residence time of the glass in the melting zone;
the separation device comprises a wall, referred to as the first wall, which is configured to prevent the molten glass from going back from the refining zone to the melting zone;
the hybrid furnace comprises a neck, referred to as first neck, which connects the melting zone to the refining zone;
the hybrid furnace comprises means for cooling the glass which are able to cool the glass in the first neck, in particular an air-circulation cooling device;
wherein the first neck comprises a bottom, the separation device comprises at least one raised portion of the bottom of said first neck, which raised portion is configured to prevent the molten glass from going back from the refining zone to the melting zone;
said at least one raised portion of the bottom comprises, from upstream to downstream, at least one ascending segment, a top segment and a descending segment;
at least one of said ascending segment and descending segment of said at least one raised portion of the bottom is inclined relative to the horizontal and/or comprises a top segment forming a plateau;
the raised portion has a maximum height that entirely or partially determines a passage section of the molten glass in the first neck;
the separation device comprises at least one barrier which, extending vertically, is partially submerged in the glass bath flowing through the first neck, from the melting zone to the glass refining zone, said barrier being configured to prevent the molten glass from going back from the refining zone to the melting zone;
the barrier is positioned at the upstream end of the first neck;
the separation device comprises the barrier and said at least one raised portion of the bottom of the first neck;
the barrier is positioned above the top segment of the raised portion of the bottom of the first neck;
the barrier is mounted so as to be vertically movable in order to allow adjustment of the submersion depth thereof in the glass bath, in order to vary the passage section of the molten glass on the basis of the adjustment of the depth of said barrier;
the barrier is removable, that is to say dismantlable, in order in particular to enable it to be changed in the event of wear and to facilitate maintenance of the furnace;
the hybrid furnace comprises separation means, such as a curtain, for separating the atmosphere of the melting zone from the atmosphere of the refining zone;
the hybrid furnace comprises blocking means which are able to retain the layer of glass batch present at the surface of the glass bath in the melting zone, said blocking means being arranged at the downstream end of the melting zone;
the blocking means are formed by the separation means, the free end of which extends at the surface of the bath, or is submerged in the glass bath;
the blocking means are separate from said separation means, said blocking means being attached to or remote from the separation means;
the hybrid furnace is configured to feed a float glass unit with a load of greater than or equal to 400 tons per day, preferentially between 600 and 900 tons per day, or even 1000 tons per day or more, with a high-quality glass having less than 0.1 bubble per liter, preferentially less than 0.05 bubble per liter;
the melting zone comprises electrodes which are submerged in the glass bath and which constitute supplementary (“booster”) electrical heating means;
the electrodes are arranged in a downstream part of the melting zone;
the electrodes of the melting zone are selectively controlled to control the first convection current in the melting zone;
the electrodes of the melting zone are selectively controlled to regulate the temperature of the glass passing from the melting zone to the first refining zone of the refining zone;
the electrodes and said at least one burner of the first refining zone are able to heat the glass to a temperature of greater than 1450° C.;
said at least one burner is arranged in the refining zone to obtain a hot spot at the surface that determines an inversion zone between the second convection current and the third convection current;
the electrodes of the first refining zone are selectively controlled to control the second convection current in the first refining zone;
the wall is configured to prevent the glass from going back from the second refining zone to the first refining zone, as a result of which the second convection current of the first refining zone is able to be controlled independently of the third convection current;
the wall is configured to limit the amount of glass passing from the first refining zone to the second refining zone so as to increase the residence time of the glass in the first refining zone;
the second refining zone comprises electrodes which are submerged in the glass and which are able to be selectively controlled to control the third convection current;
the conditioning tank of the cooling zone comprises, from upstream to downstream, a neck, referred to as second neck, then a conditioner.

The invention further proposes an assembly for the manufacture of flat glass comprising a hybrid glass-manufacturing furnace according to the invention and a float unit for floating glass on a bath of molten metal which, arranged downstream, is fed with glass by said hybrid furnace via at least one flow channel.

The invention also proposes a method for manufacturing glass in a hybrid furnace such as described above, said manufacturing method comprising the steps of:
(a)—melting a glass batch in a hot-crown melting zone comprising a first convection current of the glass;
(b)—refining the glass in a first refining zone comprising a second convection current and then in a second refining zone comprising a third convection current, said first refining zone being respectively separated from the melting zone and from the second refining zone so as to be able to control each independently of one another;
(c)—cooling the glass in a cooling zone formed by a conditioning tank through which said third convection current flows.

Advantageously, the method comprises a step of controlling the supplementary electrodes arranged in the melting zone to control said first convection current of the glass, separated by the “no-return” separation device, independently of the second convection current of the first refining zone.

Advantageously, the method comprises a step of controlling the electrodes arranged in the first refining zone to control said second convection current of the glass, separated by the wall, independently of the third convection current of the second refining zone.

Advantageously, the method comprises a step of controlling the electrodes arranged in the second refining zone to control said third convection current of the glass, the electrodes being selectively controlled to regulate the temperature of the glass in said second refining zone of the refining zone.

Advantageously, the method comprises a step of regulating the cooling of the glass in the first neck, in particular by selectively controlling the means for cooling the glass such as at least one air cooling device.

Advantageously, the amount of cooling air introduced into the first neck by the intake means of the air cooling device is controlled in particular on the basis of the temperature of the glass.

### BRIEF DESCRIPTION OF THE FIGURES

Further characteristics and advantages of the invention will become apparent upon reading the following detailed description, for the understanding of which reference is made to the appended drawings, wherein:

FIG. 1 is a side view showing a hybrid furnace for the manufacture of glass according to a first embodiment of the invention, further comprising a hybrid melting zone associated with a refining zone in two parts comprising two convection currents and a cooling zone, and which illustrates the first refining zone delimited upstream by a first wall forming the “no-return” separation device with the melting zone and downstream by a second wall ensuring separation from the second refining zone;

FIG. 2 is a top view showing the furnace according to FIG. 1 and further illustrating the electrodes arranged respectively in the melting zone, in the first refining zone and in the second refining zone, and also the cooling zone formed by a conditioning tank comprising a neck and a conditioner;

FIG. 3 is a side view which, analogously to FIG. 1, shows a hybrid furnace according to a second embodiment of the invention comprising a first neck that connects the melting zone to the refining zone in two parts, and illustrating a separation device upstream, formed by at least one raised portion of the bottom of the first neck and a wall downstream, which separation device and wall ensure separation of the first refining zone respectively from the melting zone and from the second refining zone;

FIG. 4 is a top view which, analogously to FIG. 2, shows the furnace according to FIG. 3 in which the separation device for preventing the return of the glass to the melting zone is formed by a raised portion of the bottom of the first neck, and illustrating the electrodes arranged respectively in the melting zone, in the first refining zone and in the second refining zone, and also the cooling zone formed by a conditioning tank comprising a second neck and a conditioner;

FIG. 5 is a side view showing, in detail, the first neck of the hybrid furnace according to FIG. 3 and illustrating an exemplary embodiment of said at least one raised portion of the bottom of the first neck;

FIG. 6 is a side view which shows, analogously to FIG. 5, in detail, a third embodiment of the separation device in a hybrid furnace identical to that of FIGS. 3 to 5 and which illustrates a movable barrier associated with a raised portion of the bottom of the first neck forming said separation device and also a curtain forming atmospheric separation means between the melting zone and the refining zone and ensuring, at the surface, the blocking of the glass batch in said melting zone;

FIG. 7 is a side view showing, in detail, a variant embodiment of the separation device of the hybrid furnace according to FIG. 5, comprising a first neck provided with a raised portion of the bottom (without barrier) and illustrating means for blocking the glass batch which are separate from the curtain forming the separation means, unlike those shown by FIG. 6.

### DETAILED DESCRIPTION OF THE INVENTION

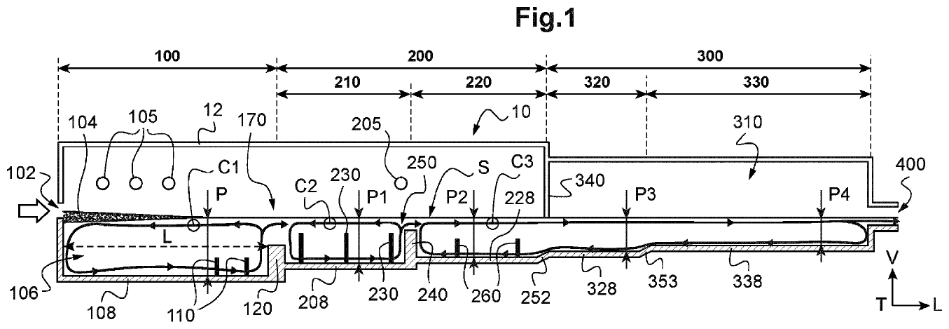

In the remainder of the description, the longitudinal, vertical, and transverse orientations will be used non-limitingly in reference to the axis system (L, V, T) shown in FIGS. 1 to 7.

Use will also be made, by convention, of the terms “upstream” and “downstream” when referring to the longitudinal orientation, as well as “upper” and “lower” or “top” and “bottom” when referring to the vertical orientation and finally “left” and “right” when referring to the transverse orientation.

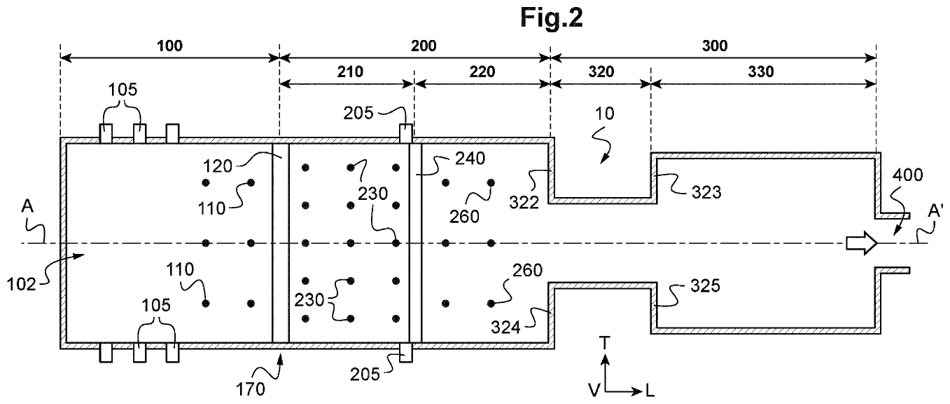

In the present description, the terms “upstream” and “downstream” correspond to the direction of flow of the glass in the furnace, with the glass flowing from upstream to downstream along a longitudinal mid axis A-A′ of the hybrid furnace (upstream being A, downstream being A′) shown in FIG. 2 or 4.

Furthermore, the terms “current” and “loop” are synonyms here, with these terms, associated with the recirculation of the glass in the furnace in a clockwise or anticlockwise direction, being well known to those skilled in the art, as are the concepts of “hot crown” and “cold crown” in a furnace intended for glass manufacture.

FIGS. 1 and 2 respectively show side and top views (which are not to scale) of a hybrid furnace 10 for manufacturing glass illustrating a first embodiment of the present invention.

By analogy with the third furnace design described above, the term “hybrid” is used here to describe the furnace according to the invention because of the use of two different energy sources: fuel energy and electrical energy, respectively.

According to one important feature, the hybrid furnace 10 according to the invention is capable of feeding a float unit for floating glass on a bath of molten metal, generally tin, for the manufacture of flat glass.

Indeed, feeding molten glass to a float unit (or “float”) requires the hybrid glass-manufacturing furnace 10 to be capable of satisfying a dual requirement, respectively of glass amount and glass quality.

Advantageously, the hybrid furnace 10 according to the invention is able to supply a high-quality glass with a load of greater than or equal to 400 tons per day, preferentially between 600 and 900 tons per day, or even 1000 tons per day or more.

Advantageously, the hybrid furnace 10 is not only able to supply the amount of glass required to feed a float unit but also to supply a high-quality glass having less than 0.1 bubble per liter, preferentially less than 0.05 bubble per liter.

The hybrid furnace 10 comprises in succession, from upstream to downstream in the longitudinal mid axis A-A′ of the furnace, at least one melting zone 100, a refining and homogenization zone 200, hereinafter referred to as refining zone, and a glass cooling zone 300.

The hybrid furnace 10 is of the “hot-crown” type, hereinafter denoted by the reference numeral 12 in the melting zone 100.

According to a first feature of the invention, the melting zone 100 of the hybrid furnace 10 comprises a first convection current (C1) forming a glass recirculation loop in the anticlockwise direction.

Preferably, the hybrid furnace 10 comprises at least one charging opening 102 through which a glass batch 104 is introduced into an upstream part of the melting zone 100, here longitudinally in the mid axis A-A′ of the furnace as shown by an arrow in FIG. 1.

In a known manner, the glass batch 104 (also referred to as “composition”) comprises raw materials and cullet. Cullet consists of glass debris, obtained by recycling glass, which is ground and cleaned before being subsequently added to the raw materials in order to manufacture glass again.

Advantageously, cullet promotes melting, that is to say the transformation of the glass batch into glass by melting.

In addition, cullet makes it possible to repurpose used glass by recycling it (since glass is infinitely recyclable), the amounts of raw materials necessary for the manufacture of the glass thus being reduced proportionally, which contributes to reducing the carbon footprint of the production process.

In a known manner, the glass batch 104 is introduced into the melting zone 100 of the hybrid furnace 10 by a charging device (not shown), also referred to as a batch charger.

The melting zone 100 having a hot crown 12 comprises at least some burners 105 that are able to melt the glass batch 104 to obtain a glass bath 106.

In the melting zone 100, the thermal energy released by the combustion performed by the burners 105 is transmitted directly to the glass batch and more generally to the glass bath 106 by radiation and convection; another part is transmitted by the crown 12 which returns it by radiation, and which is therefore referred to as “hot crown”.

As shown in FIGS. 1 and 2, the burners 105 are advantageously arranged in the upstream part of the melting zone 100, the number of burners 105, for example three here, shown being purely illustrative and therefore entirely non-limiting.

The burners 105 of the melting zone 100, referred to as aerial burners, are arranged between the hot crown 12 and the surface of the molten glass bath 106 which is partially covered, in particular upstream, by the glass batch 104 shown using dots in FIG. 1.

Preferably, the burners 105 of the melting zone 100 are what are referred to as cross-firing burners, commonly given this name because of their transverse arrangement, perpendicular to the flow of the glass in the hybrid furnace 10, from upstream to downstream along the mid axis A-A′.

The flame produced by combustion by the cross-firing burners 105 extends transversely such that it is possible to adjust the longitudinal distribution of the temperatures by regulating the power of each of the burners 105.

Preferably, the burners 105 are arranged transversely on either side of the melting zone 100 as shown by FIG. 2.

The combustion performed by the burners 105 can be obtained in a known manner by combining different types of fuel and oxidizer but the choice of which also has direct consequences on the carbon footprint of the glass manufacture, i.e. direct and indirect greenhouse gas emissions associated with the manufacture of the product, in particular carbon dioxide (CO₂) emissions.

For the combustion by the burners 105 of the melting zone 100, the oxygen present in the air is generally used as oxidizer, which air can be enriched with oxygen in order to obtain oxygen-enriched air, or even virtually pure oxygen is used in the particular case of oxy-fuel combustion.

Generally, the fuel used is natural gas. However, in order to improve in particular the carbon footprint, use will advantageously be made of a green fuel, in particular a “biogas”, i.e. a gas composed essentially of methane and carbon dioxide which is produced by methanization, in other words the fermentation of organic materials in the absence of oxygen, or even preferentially “biomethane” (CH₄).

Use will even more preferentially be made of hydrogen (H₂) which, compared with a biogas, advantageously does not comprise carbon.

Advantageously, the hybrid glass-manufacturing furnace 10 according to the invention may comprise regenerators made of refractory materials operating (for example in pairs and inverted) or else metal air/flue gas exchangers (also referred to as recuperators) which respectively use the heat contained in the flue gases resulting from manufacturing to preheat the gases and thus improve combustion.

Advantageously, the burners 105 of the hybrid furnace 10 are able to melt the glass batch 104 over a surface area of less than 0.3 m₂ per ton of glass.

Such a surface area would be comparatively larger with an electric furnace according to the second design, and therefore the fuel-fired hybrid furnace 10 has the advantage of being more compact.

In addition, the burners 105 also make it possible to carry out the step of melting the glass batch 104 at lower temperatures compared to electrical melting, which contributes to reducing phenomena of wear of the infrastructure of the furnace, favoring an increase in the lifetime of the furnace.

In a glass-manufacturing furnace, all the blocks in contact with the glass are conventionally referred to as “infrastructure”, and all the materials arranged above the infrastructure are conventionally referred to as “superstructure”.

The superstructure material, arranged above the tank blocks of the infrastructure and not in contact with the glass but with the atmosphere inside the furnace, is generally of a different nature than that of the tank blocks of the infrastructure.

Even if the material used for the superstructure is similar to that of the infrastructure, for example in the case of a hot crown as in the present embodiment, a distinction is generally made between these two parts of the structure of a furnace.

The hybrid furnace 10 comprises a bottom 108. Preferably, the bottom 108 here is planar in the melting zone 100 such that the depth P of the glass bath 106 between the surface of the bath 106 and the bottom 108 is substantially constant.

Preferably, the melting zone 100 comprises electrodes 110 which are submerged in the glass bath 106 and which advantageously constitute supplementary (“booster”) electrical heating means.

Indeed, the electrodes 110 in the melting zone 100 are complementary heating means in relation to the burners 105 which constitute the main heating means making it possible to melt the glass batch 104. The step of melting the glass is consequently obtained using fuel energy and, as a supplement, electrical energy.

Preferably, heat supplied by the electrodes 110, as a supplement to the burners 105, is between 5 and 25% of the total heat of the melting step carried out in the melting zone 100, preferentially of the order of 10 to 15%.

Preferably, the electrodes 110 are mounted through the bottom 108 of the melting zone 100 of the furnace via electrode holders (not shown), which in particular make it possible to power them electrically.

Preferably, the electrodes 110 extend vertically as shown by FIG. 1. Alternatively, the electrodes 110 extend obliquely, i.e. are inclined so as to have a given angle relative to the vertical orientation.

According to another alternative arrangement, the electrodes 110 pass through at least one side wall delimiting said melting zone 100, said electrodes 110 then extending horizontally and/or obliquely.

Advantageously, the electrodes 110 are made of molybdenum; this refractory metal, which withstands temperatures of 1700° C., being particularly suitable for heating the glass bath 106 in the melting zone 100.

Moreover, and as for the burners 105, the number of six electrodes 110 shown here in FIGS. 1 and 2 is purely illustrative and therefore entirely non-limiting.

Preferably, the melting electrodes 110 are distributed transversely and evenly in the melting zone 100.

Advantageously, the electrodes 110 are arranged in a downstream part of the melting zone 100 that extends over more than half the length (L) of said melting zone 100, or even over more than two thirds of said length (L).

The hybrid furnace 10 may advantageously comprise bubblers (not shown) which are for example arranged in the melting zone 100, that is to say a system for injecting at least one gas, such as air or nitrogen, at the bottom, the bubbles of which then create an upward movement of the glass.

The melting zone 100 of the hybrid furnace 10 is delimited downstream by a “no-return” separation device 170, which is configured to prevent the molten glass from going back to said melting zone 100 comprising the first convection current (C1).

In this first embodiment, the “no-return” separation device 170 consists of a wall 120, referred to as first wall, which is positioned downstream of the melting zone 100 of the hybrid furnace 10.

As shown in FIGS. 1 and 2, the first wall 120 thus delimits the melting zone 100 comprising the first convection current (C1), said wall 120 preferentially extending over the entire width of the melting zone 100, transversely from one wall to the other.

Furthermore, the melting zone 100 is connected to the refining zone 200 by walls extending longitudinally and rectilinearly such that said zones 100 and 200 have the same width.

Preferably, at least part of said electrodes 110 is arranged in the vicinity of said first wall 120 delimiting the melting zone 100 downstream, said electrodes 110 being arranged in the downstream part of the melting zone 100 which extends starting from the halfway point of the length of said melting zone.

Depending on their number, for example equal to six in FIGS. 1 and 2, the electrodes 110 are preferentially arranged over more than two thirds of said length.

According to a second feature of the invention, the refining zone 200 comprises a second convection current (C2), referred to as upstream recirculation loop, and a third convection current (C3), referred to as downstream recirculation loop.

The glass refining zone 200 comprises a first refining zone 210 and a second refining zone 220, said first refining zone 210 advantageously comprising at least one burner 205, or even two burners, and electrodes 230.

The number and position of the burner 205 and of the electrodes 230, shown in FIGS. 1 and 2, respectively, are purely illustrative and therefore entirely non-limiting.

The first refining zone 210 is respectively separated from the melting zone 100 by the first wall 120 forming the “no-return” separation device 170 and from the second refining zone 220 by a second wall 240.

In the refining zone 200 of the hybrid furnace 10, the glass thus recirculates in the first refining zone 210 in the anticlockwise direction following the second convection current (C2) and in the second refining zone 220 in the clockwise direction following the third convection current (C3).

Advantageously, the first wall 120 is configured to prevent the glass from going back from the first refining zone 210 to the melting zone 100 such that the melting zone 100 and the first refining zone 210 are separated from each other.

Advantageously, the first convection current (C1) in the melting zone 100 is separated from the second convection current (C2) in the first refining zone 210, as a result of which it thus becomes possible to control each of said currents C1, C2 independently of each other.

Advantageously, the first wall 120 is configured to limit the amount of glass passing from the melting zone 100 to the first refining zone 210 so as in particular to increase the residence time of the glass in the melting zone 100.

Indeed, the first wall 120 extends vertically from the bottom 108 of the furnace over a determined height with a top part submerged below a surface (S) of the glass.

In the hybrid furnace 10, the glass is taken from the melting zone 100 to the first refining zone 210 over the first wall 120.

In addition to preventing any return by separating said currents C1 and C2, the height of the first wall 120 therefore also determines a section for the passage of the glass from the melting zone 100 to the first refining zone 210.

By virtue of the first wall 120, the melting zone 100 is able to be controlled independently of the first refining zone 210, in particular by selectively controlling the electrodes 110 to control the first convection current (C1).

Indeed, the arrangement of the electrodes 110 submerged in the downstream part of the melting zone 100 makes it possible to create a hotter point therein in the glass bath 106 relative to the upstream part in which the burners 105 are arranged above the surface of the bath 106 covered with the glass batch 104.

Advantageously, the electrodes 110 also make it possible to regulate the temperature of the glass passing from the melting zone 100 to the first refining zone 210.

Like the first wall 120, the second wall 240 extends vertically from a bottom 208 of the first refining zone 210 of the furnace over a determined height, with a top part submerged below a surface (S) of the glass which determines a section for the passage of the glass from the first refining zone 210 to the second refining zone 220 of the refining zone 200.

Advantageously, the second wall 240 is configured to prevent the glass from going back from the second refining zone 220 to the first refining zone 210, as a result of which the second convection current (C2) in the first refining zone 210 and the third convection current C3 are separated and are able to be controlled independently of one another.

Like the first wall 120, the second wall 240 advantageously makes it possible to increase the residence time of the glass in the first refining zone 210, which contributes directly to obtaining high-quality glass.

Preferably, the bottom 208 is flat. As shown in FIG. 1, the hybrid furnace 10 comprises at least one variation in the depth of the bottom relative to the surface S of the glass.

Preferably, the hybrid furnace 10 comprises, for example, a raised portion of the bottom 208 of the first refining zone 210 relative to the bottom 108 of the melting zone 100, such that the depth P1 of glass in the first refining zone 210 is less than the depth P of the glass in the melting zone 100.

Advantageously, the electrodes 230 and said at least one burner 205 of the first refining zone 210 are able to heat the glass to a temperature of greater than 1450° C.

By virtue of the first wall 120 and the second wall 240, the first refining zone 210 is separated from the melting zone 100 and from the second refining zone 220, respectively, isolated from the others in the absence of return, the first refining zone 210 can be controlled independently.

Thus, the hybrid furnace 10 comprises three currents C1, C2 and C3, respectively independent of one another.

In the first refining zone 210, the electrodes 230 submerged in the glass make it possible to bring it to a temperature which is determined only on the basis of the refining and in particular independently of the melting zone 100.

Indeed, in the absence of return and due to the separation between the first convection current C1 and the second convection current C2, the heat provided by the electrodes 230 is only used for refining and, in so doing, is advantageously used in an optimal manner.

Similarly, the heat provided by the burners 105 and the supplementary electrodes 110 in the melting zone 100 is intended for the glass melting step, without which it would be necessary to take the refining step into account.

Advantageously, the temperature in the melting zone 100 and the temperature in the first refining zone 210 can be controlled independently of each other.

Preferably, in the first glass refining zone 210, the heat is mainly provided by the electrodes 230, said at least one burner 205 only intervening in a supplementary manner, and therefore electrical energy predominates over fuel energy in the supply of heat, unlike in the melting zone 100.

Alternatively, the first glass refining zone 210 only comprises burners and no electrodes 230, with the glass then only being heated at the surface.

Nevertheless, the electrodes 230 are advantageous due to their heating efficiency as soon as said electrodes 230 are submerged directly in the molten glass originating from the melting zone 100.

Preferably, the electrodes 230 here are longer than the electrodes 110, for example so as to further improve the heating of the glass in the first refining zone 210 by increasing the surface area for heat exchange with the glass.

Said at least one burner 205 is arranged in the refining zone 200 to obtain a hot spot (or point source) at the surface that determines an inversion zone 250 between the second convection current C2 and the third convection current C3.

Preferably, the hybrid furnace 10 comprises another variation in the depth of the bottom relative to the surface (S) of the glass between the first refining zone 210 and the second refining zone 220, more precisely a raised portion of a bottom 228 of the second refining zone 220.

As shown in FIG. 1, the glass depth P2 in the second refining zone 220 is thus less than the glass depth P1 in the first refining zone 210.

According to a third feature of the invention, the glass-cooling zone 300 comprises a conditioning tank 310, through which said third convection current (C3) flows.

Advantageously, the conditioning tank 310 of the cooling zone 300 comprises, from upstream to downstream, a neck 320, i.e. a zone of reduced width as shown in FIG. 2, then a conditioner 330.

Passage from the second refining zone 220 to the neck 320 is achieved by an abrupt narrowing of the width and of the passage section of the glass, for example here by walls 322 and 324 forming an angle of 90° with the longitudinal mid axis A-A′ of the furnace.

Alternatively, the angle at the entrance of the neck 320 could have a value that is greater than 90°, such that the narrowing of the width is less abrupt and more gradual.

Passage from the neck 320 to the conditioner 330 is achieved by an abrupt widening of the passage section of the glass, for example here by walls 323 and 325 forming an angle of 90° with the longitudinal mid axis A-A′ of the furnace.

Analogously, the value of the angle at the exit of the neck 320 could be chosen so that the widening is also less abrupt and more gradual in the longitudinal mid axis A-A′ of the furnace.

Advantageously, the atmosphere of the refining zone 200 and the colder atmosphere of the cooling zone 300 are separated from each other by a heat screen 340, such as a partition, extending vertically from the crown in the cooling zone 300 to the vicinity of the surface S of the glass, preferentially without dipping into the glass.

Preferably, the hybrid furnace 10 further comprises another variation in the depth of the bottom relative to the surface (S) of the glass between the second refining zone 220 and the cooling zone 300.

Preferably, the hybrid furnace 10 comprises a first raised portion of a bottom 328 of the neck 320 relative to the bottom 228 of the second refining zone 220. The glass depth P3 in the neck 320 is thus less than the glass depth P2 in the second refining zone 220.

Advantageously, the bottom 228 of the second refining zone 220 is joined to the bottom 328 of the neck 320 by a segment 252 which is inclined so as to ensure a gradual passage of the glass from the depth P2 to the depth P3.

Preferably, the hybrid furnace 10 comprises a second raised portion of a bottom 338 of the conditioner 330 relative to the bottom 328 of the neck 320. The glass depth P4 in the conditioner 330 is thus less than the glass depth P3 in the neck 320.

Advantageously, the bottom 328 of the neck 320 is joined to the bottom 338 of the conditioner 330 by a segment 353 which is inclined so as to ensure a gradual passage from the depth P3 to the depth P4.

Preferably, the glass depth in the hybrid furnace 10 successively decreases from upstream to downstream, from the melting zone 100 to the conditioner 330 of the cooling zone 300.

Nevertheless, the raised portions of the bottom of the hybrid furnace 10 that have just been described with reference to the embodiment shown by FIGS. 1 and 2 are just one example of depth variations which could alternatively comprise one or more differences in level.

Preferably, the second refining zone 220 comprises electrodes 260 submerged in the glass. Alternatively, the electrodes 260 are replaced by at least one burner.

The number and position of the electrodes 260 shown in FIGS. 1 and 2 are purely illustrative and therefore entirely non-limiting.

Advantageously, the electrodes 260 of the second refining zone 220 are selectively controlled to control the third convection current (C3), which the glass follows as it recirculates in the clockwise direction.

Indeed, the third convection current (C3) extends longitudinally from the second refining zone 220 to the conditioner 330, also passing through the entire cooling zone 300, and therefore the supply of heat from the only glass collected in the first refining zone 210 may be insufficient.

The electrodes 260 are advantageously submerged in the glass and arranged in the second refining zone 220, and are thus able to create a hot spot upstream in order to control the third convection current (C3), referred to as the downstream recirculation loop.

As explained previously, by virtue of the configuration of the second wall 240, the glass does not go back from the second refining zone 220 to the first refining zone 210; the second convection current (C2) can be controlled independently of the third convection current (C3).

Advantageously, the electrodes 260 also contribute to perfecting the refining performed in the first refining zone 210.

The conditioning tank 310 is connected to a flow channel 400 located downstream of the conditioner 330.

Advantageously, after the conditioning tank 310, there is no return current in the flow channel 400 intended to feed glass to a forming zone; in other words, the flow of the glass in the channel 400 is a “piston”-type flow.

Advantageously, the hybrid furnace 10 is able to feed a float unit for floating glass on a bath of molten metal with a load of greater than or equal to 400 tons per day, preferentially between 600 and 900 tons per day, or even 1000 tons per day or more, with high-quality glass, i.e. glass having less than 0.1 bubble per liter.

Advantageously, the hybrid furnace 10 according to the invention is able to supply high-quality glass having less than 0.1 bubble per liter, or even preferentially less than 0.05 bubble per liter.

Advantageously, such high-quality glass is most particularly suited for feeding a float unit for floating glass on a bath of molten metal intended for the manufacture of flat glass.

The invention also relates to a method for manufacturing glass in a hybrid furnace 10 such as that of the embodiment that has just been described with reference to FIGS. 1 and 2.

This manufacturing method comprises the following steps:
(a)—melting a glass batch in a hot-crown melting zone 100 comprising a first convection current C1 of the glass;
(b)—refining the glass in a first refining zone 210 comprising a second convection current (C2) and then in a second refining zone 220 comprising a third convection current (C3), said first refining zone 210 being respectively separated from the melting zone 100 and from the second refining zone 220 so as to be able to control each independently of one another;
(c)—cooling the glass in a cooling zone 300 formed by a conditioning tank 310 through which said third convection current (C3) flows.

Advantageously, the method comprises a step (a1) of controlling supplementary electrodes 110 arranged in the melting zone 100 to control said first convection current (C1) of the glass.

The electrodes 110 are selectively controlled to regulate the temperature of the glass passing from said melting zone 100 to the first refining zone 210.

Advantageously, the first convection current (C1) separated by the separation device 170 formed by the first wall 120 in this first embodiment is controlled independently of the second convection current (C2) of the first refining zone 210.

Advantageously, the method comprises a step (b1) of controlling electrodes 230 arranged in the first refining zone 210 to control said second convection current (C2) of the glass.

Advantageously, the second convection current (C2) of the glass, separated by the second wall 240, is controlled independently of the third convection current (C3) of the second refining zone 220.

Advantageously, the method comprises a step (b2) of controlling heating means such as at least one burner and/or electrodes, preferentially here electrodes 260, arranged in the second refining zone 220 to control said third convection current (C3) of the glass.

Advantageously, the electrodes 260 are selectively controlled to regulate the temperature of the glass in said second refining zone 220 of the refining zone 200.

In a hybrid furnace 10 according to the invention, the contribution made by electrical energy in the provision of heat by the electrodes 110, 230 and 260 advantageously amounts to more than 40% of the total heat provided to the furnace.

The design of the hybrid furnace 10 according to the invention advantageously makes it possible to finely control each of the steps of melting, refining and cooling of the glass manufacturing method, thereby guaranteeing energy efficiency.

By virtue of the first wall 120 forming the separation device 170 and of the second wall 240, respectively configured to prevent any return, the melting, refining and cooling zones are advantageously separated from one another, thus making it possible to control the convection current in each independently from the convection current located downstream.

Advantageously, the design of the hybrid furnace 10 makes it possible to optimize the energy efficiency of the furnace by providing as close as possible to the precise amount of heat necessary for each step of the glass-making process, thereby improving the carbon footprint.

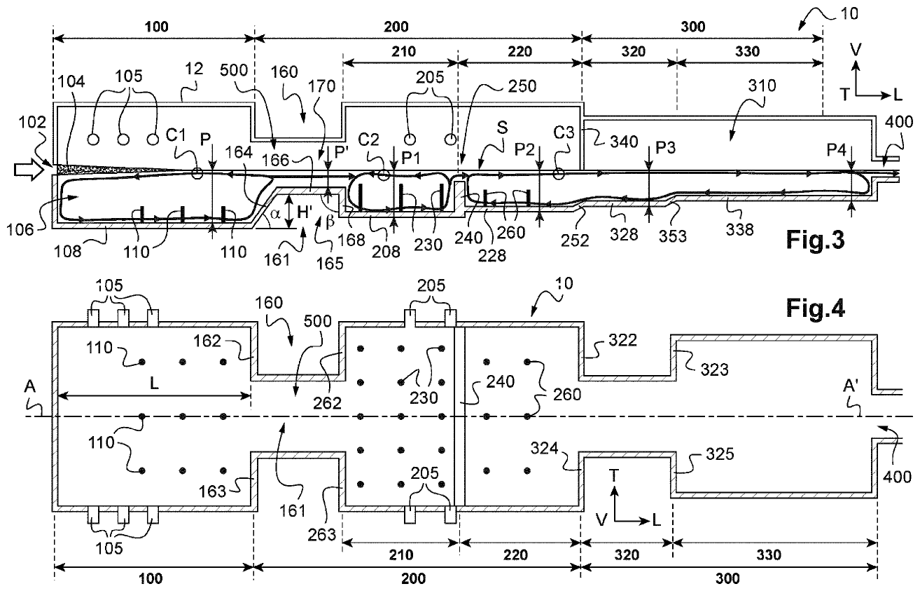

A second embodiment of a hybrid furnace 10 according to the invention, as shown in FIGS. 3 to 5, will be described below in comparison with the first embodiment shown in FIGS. 1 and 2.

In this second embodiment, the burners 105 are also three in number, preferentially arranged upstream, near the charging opening 102 for the glass batch 104. However, the number of electrodes 110 here is nine, as shown in FIGS. 3 and 4.

Advantageously, the heat supplied by the electrodes 110, as a supplement to the burners 105, is at least 40% of the total heat of the melting step carried out in the melting zone 100, preferentially between 50 and 70%.

In general, it will be recalled, however, that the number of burners or electrodes is purely illustrative and thus entirely non-limiting.

Preferably, the melting electrodes 110 are distributed transversely and evenly in the melting zone 100.

Advantageously, the electrodes 110 are mainly arranged in a downstream part of the melting zone 100, taking into account in particular their greater number (equal to nine and not six) here, in the two thirds of said melting zone 100 which extends over a length (L).

According to one feature of this second embodiment, the hybrid furnace 10 comprises a neck 160, referred to as first neck, connecting the melting zone 100 to the refining zone 200, more specifically to the first refining zone 210.

Advantageously, said first neck 160 of the hybrid furnace makes it possible to ensure cooling of the glass when the glass flows from the melting zone 100 to the first refining zone 210 of the glass refining zone 200.

The cooling of the glass will be greater the longer the first neck 160 is, since the glass originating from the melting zone 100 naturally cools as it flows from upstream to downstream through the first neck 160.

Preferably, the first neck 160 has a length configured to obtain a reduction in the temperature of the molten glass intended to subsequently flow into the first refining zone 210.

As indicated above, the molten glass has a higher temperature in the melting zone 100, the greater the supply of heat by the electrodes 110 is.

Advantageously, the hybrid furnace 10 comprises means 500 for cooling the glass which are able to selectively cool the glass in the first neck 160.

In addition to the cooling of the glass as it flows through the first neck 160 connecting the melting zone 100 to the first refining zone 210, the cooling means 500 make it possible to further increase the cooling and especially to vary this cooling so that regulation of the temperature of the glass is then advantageously obtained.

Preferably, the means 500 for cooling the glass in the first neck 160 comprise at least one air-circulation cooling device 510.

An exemplary embodiment of a cooling device 510 such as more particularly shown schematically in FIGS. 6 and 7 which illustrate, respectively, a third embodiment and a variant, will be described below, and therefore reference will advantageously be made to said figures.

When the hybrid furnace 10 comprises such an air cooling device 510 in the first neck 160, the hybrid furnace 10 comprises at least one separation means 174 for separating the atmosphere of the melting zone 100 and of the first neck 160.

An exemplary embodiment of such an atmospheric separation means 174 is shown in said FIGS. 6 and 7 and will be described in more detail below.

Such an air cooling device 510 for the glass comprises for example at least intake means 512 for introducing cooling air into the atmosphere of said first neck 160 of the hybrid furnace 10.

Preferably, the device 510 for cooling the glass comprises discharge means 514 arranged in the first neck 160 to discharge the hot air and ensure renewal thereof by fresh cooling air.

Alternatively, the discharge means are formed by extraction means (not shown) which are located downstream of the first neck 160 and are intended to extract the flue gases. Advantageously, the hot air is then discharged with the flue gases by said extraction means without the hybrid furnace 10 having to be equipped with additional means.

The air intake means 512 and the air discharge means 514 of the glass cooling device 510 are for example formed by one or more openings that open into the breast walls supporting the crown of the first neck 160.

Said at least one intake opening and said at least one discharge opening, schematically shown in FIGS. 6 and 7, are for example located longitudinally opposite one another, the intake opening(s) being arranged in the upstream part of the first neck 160 while the discharge opening(s) are arranged in the downstream part of the first neck 160.

The air intake means 512 and the air discharge means 514 are for example arranged transversely on either side of the first neck 160, or alternatively on only one side of the first neck 160.

Advantageously, the temperature of the cooling air introduced into the first neck 160 is lower than the temperature of the hot air located inside said first neck 160, with the circulated cooling air forming a heat-transfer fluid.

Preferably, the cooling air used is atmospheric air collected outside the hybrid furnace 10, or even outside the confines of the building in which said hybrid furnace 10, feeding a float unit, is installed.

Advantageously, the temperature of the atmospheric air used is controlled in order to be regulated; the air may for example be previously cooled or heated before being introduced, in order to control the temperature thereof.

The glass is mainly cooled by convection, the cooling air which is introduced heating in particular upon contact with the surface of the glass before being discharged with the heat (the calories) transmitted by the glass.

Advantageously, the circulation of air can be controlled by air-blowing means (not shown) such as fans which, associated with said intake means 512 and/or with the discharge means 514, can be controlled in order to vary the flow rate of circulating air.

Advantageously, the glass manufacturing method according to the invention comprises a step of regulating the cooling of the glass in the first neck 160, in particular by selectively controlling the means 500 for cooling the glass such as at least one air cooling device 510 according to the embodiment which has just been described.

Advantageously, the amount of cooling air introduced into the first neck 160 by the intake means 512 of the air cooling device 510 is controlled in particular on the basis of the temperature of the glass.

Alternatively or in combination with an air cooling device 510, the hybrid furnace 10 comprises means 500 for cooling the glass which are submerged in the glass flowing from upstream to downstream through said first neck 160 in order to enable cooling thereof.

Such cooling means 500 are for example formed by vertical studs submerged in the glass which are cooled by a cooling circuit containing heat-transfer fluid in order to discharge the heat transmitted to the studs by the glass.

According to another exemplary embodiment, the cooling means 500 are able to cool the structure of the first neck 160 in contact with the glass, the cooling being carried out from the outside of the structure of the first neck 160.

Of course, the cooling means 500 associated with the first neck 160, such as those according to the various examples that have just been described, can be implemented alone or in combination.

Advantageously, the means for cooling the glass associated with the first neck 160 make it possible to selectively control the temperature of the glass, which temperature is likely to vary, in particular when the load varies; this is because an increase in the load causes an increase in the temperature of the glass.

By comparison with such means for cooling the glass associated with the first neck 160, such a variable cooling of the glass would not be possible with a throat.

Preferably, passage from the melting zone 100 to the first neck 160 is achieved by an abrupt narrowing of the width and of the passage section of the glass, for example here by walls 162 and 163 forming an angle of 90° with the longitudinal mid axis A-A′ of the furnace.

Preferably, passage from the first neck 160 to the glass refining zone 200 is achieved by an abrupt widening of the passage section of the glass, for example here by walls 262 and 263 forming an angle of 90° with the longitudinal mid axis A-A′ of the furnace.

Alternatively, the angle at the entry of the first neck 160 could have a value greater than 90° such that the narrowing of the width is less abrupt and more gradual; analogously, the value of the angle at the exit of the first neck 160 could be chosen such that the widening is also less abrupt and more gradual along the longitudinal mid axis A-A′ of the furnace.

Advantageously, the molten glass flowing from upstream to downstream through the first neck 160 is collected following the first current (C1) in the lower part of the melting zone 100, in particular after having passed through the part in which the electrodes 110 are arranged.

Advantageously and by comparison, the first neck 160 is less sensitive to wear caused by the continuous flow of molten glass than a throat in which all the refractory elements of the infrastructure are in contact with the glass of the load flowing from upstream to downstream.

Indeed, in the first neck 160, part of the flowing glass is in contact with the atmosphere via the surface S.

According to a variant not shown in FIGS. 3 to 5, the hybrid furnace 10 comprises atmospheric separation means for separating the atmosphere of the melting zone 100 from the atmosphere of the refining zone 200.

Such atmospheric separation means are, for example, analogous to those provided with the reference numeral “174” which will be described below with reference to FIGS. 6 and 7, in which said atmospheric separation means are formed by a partition (or a curtain).

The first neck 160 comprises a bottom which is provided with the reference numeral 165 in FIGS. 3 to 5. In this second embodiment, the separation device 170 consists of at least one raised portion 161 of the bottom 165 of said first neck 160.

By comparison with a first wall 120, said raised portion 161 is directly formed by the bottom 165 and not attached thereto, and therefore the raised portion 161 consists of the refractory material of the infrastructure forming said bottom 165 of the first neck 160.

Advantageously, said at least one raised portion 161 is less sensitive to wear than a first wall 120 which is a narrow and thin structure.

Advantageously, said at least one raised portion 161 is wide in that it extends longitudinally over the majority of the length of the first neck 160, said raised portion 161 advantageously contributing to the cooling of the glass in the first neck 160.

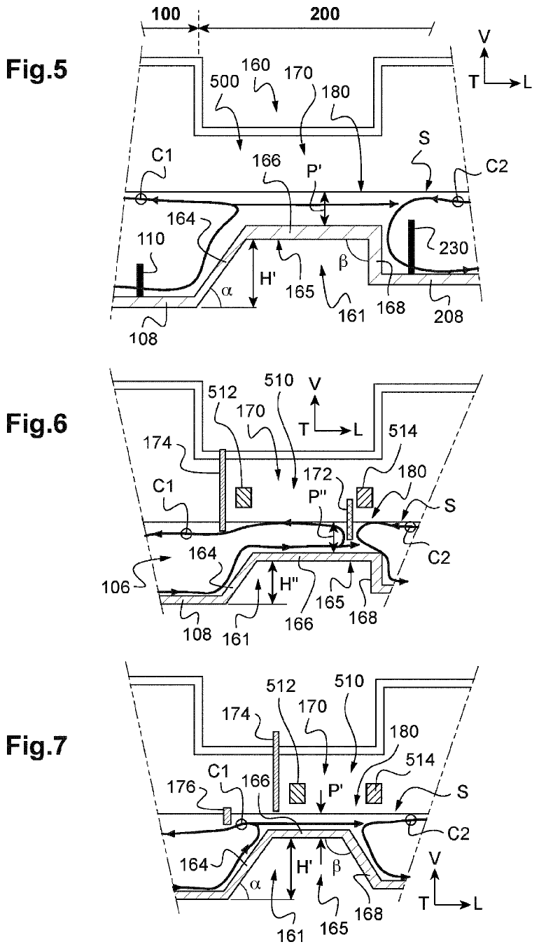

As shown in detail by FIG. 5, said raised portion 161 comprises, in succession from upstream to downstream, at least one first ascending segment 164, a second top segment 166 and a third descending segment 168.

Advantageously, the raised portion 161 extends transversely over the entire width of the first neck 160, from one longitudinal wall to the other.

Of course, such a raised portion 161 may have numerous geometric variants as regards its general shape, its dimensions, in particular depending on the configuration of each of the different segments 164, 166 and 168 that form it.

FIG. 5 shows in detail the first neck 160 of a hybrid furnace 10 according to the second embodiment of FIG. 3 in order to illustrate an example of said at least one raised portion 161.

Preferably, the ascending segment 164 is inclined by an angle (α) determined so as to form a ramp able to cause the molten glass to rise towards the top segment 166 of the raised portion 161.

Preferably, the ascending segment 164 is an inclined plane, having for example an acute angle (α) of between 20° and 70°, said angle (α) being denoted as the angle between the ascending segment 164 of the raised portion 161 and the horizontal, taking the flat bottom 108 of the melting zone 100 as reference here.

As a variant (not shown), the ascending segment 164 is stepped, for example, made in the form of a staircase having at least one step, or even two or more steps, the height and/or length dimensions of which may or may not be identical.

Preferably, the top segment 166 is flat, forming a horizontal plateau. Advantageously, the top segment 166 thus extends longitudinally over a given length, preferably here greater than or equal to half the total length of the first neck 160.

The top segment 166 determines a maximum height H′ that the raised portion 161 has, and in so doing also determines a depth P′ relative to the surface S of the glass, i.e. a passage section 180 of the molten glass in the first neck 160.

Preferably, the descending segment 168 of the raised portion 161 extends vertically, connected by a right angle (β) to the downstream end of the top segment 166 which, extending horizontally, has a flat upper surface.

According to another embodiment, as shown by FIG. 7, which will be described below, the descending segment 168 is configured to gradually accompany the flow of the molten glass from the first neck 160 to the refining zone 200.

Such a segment 168 is for example formed by an inclined plane, which may or may not be stepped, in particular made in the form of a staircase like the description given above for the variant embodiments of the ascending segment 164.

The separation device 170 is therefore formed by at least said raised portion of the bottom 165 in this second embodiment, which raised portion 161 provides a function identical to that of the wall 120 of the first embodiment, or even to that of the two walls in the case of the embodiment not shown.

In a variant, not shown, the separation device 170 comprises at least one barrier which, extending vertically, is partially submerged in the glass bath 106 flowing through the first neck 160, from the melting zone 100 to the glass refining zone 200, said barrier being configured to prevent the molten glass from going back from the refining zone 200 to the melting zone 100.

Preferably, the barrier is thus positioned at the upstream end of the first neck 160.

The use of such a barrier was described in patent application EP-21306609.5 filed on Nov. 18, 2021 in the name of the Applicant, for a hybrid furnace of different design comprising a cold-crown electrical melting zone.

According to the teaching of this application, such a barrier is capable on its own of constituting a separation device 170 within the meaning of the invention.

Advantageously, such a barrier can also be used in combination with a raised portion 161 of the bottom 165 according to the second embodiment.

Thus, the (no-return) separation device 170 can consist of a barrier and/or a raised portion 161 of the bottom 165 of the first neck 160.

FIG. 6 shows such a variant embodiment that will be described by comparison with FIG. 5.

According to this variant, the hybrid furnace 10 comprises a separation device 170 comprising a barrier 172 which is associated with said at least one raised portion 161 of the bottom 165 of the first neck 160.

Advantageously, the barrier 172 contributes to cooling the glass in the first neck 160 by limiting the flow in the first neck 160 and by virtue of the cooling circuit containing heat-transfer fluid of the “water jacket” type which makes it possible to discharge part of the heat (calories) transmitted by the glass to the barrier 172.

As shown in FIG. 6, the barrier 172 extends vertically and is partially submerged in the glass bath 106 flowing through the first neck 160 from the melting zone 100 to the glass refining zone 200.

Preferably, the barrier 172 is positioned above the top segment 166 of the raised portion 161 of the bottom 165 of the first neck 160.

Advantageously, the barrier 172 is mounted so as to be vertically movable in order to allow adjustment of the submersion depth thereof in the glass bath 106, in order to vary the passage section 180 of the molten glass on the basis of the adjustment of the depth of said barrier 172; in the absence of a barrier 172, the passage section corresponds by default to a depth P″ of glass determined by said at least one raised portion 161 having a given height H″.

Preferably, the height H″ here is less than the height H′, and therefore the depth P″ is greater than the depth P′.

Advantageously, the barrier 172 is removable, that is to say dismantlable, in order in particular to enable it to be changed in the event of wear and to facilitate maintenance of the furnace.

As indicated above, the hybrid furnace 10 advantageously comprises separation means 174, such as a curtain, for separating the atmosphere of the melting zone 100 from the atmosphere of the refining zone 200.

Advantageously, such a separation means 174 makes it possible to isolate the atmosphere of the first neck 160 from that of the melting zone 100, in particular when an air cooling device is implemented as means for cooling the glass in the first neck 160.

Advantageously, the hybrid furnace 10 comprises blocking means 176 (also referred to as a “skimmer”) which, arranged at the downstream end of the melting zone 100, are able, if necessary, to keep part of the glass batch layer 104 in the melting zone 100 in order to ensure that said glass batch present at the surface of the glass bath 106 does not penetrate into the refining zone 200.

As shown in FIG. 6, the blocking means 176 are formed by the separation 174, the free end of which extends at the surface of the bath 106, or is submerged in the glass bath 106.

FIG. 7 shows another variant embodiment that will be described by comparison with FIG. 6.

In this variant, the blocking means 176 are structurally separate from said separation means 174, it being possible for said blocking means 176 to be attached to or remote from the separation means 174 as shown in FIG. 7.

By comparison with the variant of FIG. 6, the “no-return” separation device 170 is formed here by the sole raised portion 161, said raised portion 161 of the bottom 165 of the first neck 160 having a height H′ that determines a depth P′ as in the embodiment of FIGS. 3 to 5 that does not implement a barrier 172.

The variant embodiment according to FIG. 7 also shows a different shape of the raised portion 161 compared to that of the embodiment of FIGS. 3 to 5.

Indeed, in this variant, the descending segment 168 is configured to gradually accompany the flow of the molten glass toward the refining zone 200.

Such a segment 168 is thus formed by an inclined plane, which may or may not be stepped, in particular in the form of a staircase.

Preferably, the segment 168 is inclined by an angle (β) determined so as to form a ramp able to cause a gradual descent of the molten glass toward the bottom 208 of the refining zone 200.

For the descending segment 168, the angle (β) is an obtuse angle which may for example have a value of between 90° and 145°, said angle (β) corresponding to the internal angle denoted at the point at which the top segment 166 joins the descending segment 168 in FIG. 7.

As a variant (not shown), the segment 168 is not flat but is stepped, for example, made in the form of a staircase having at least one step, or even two or more steps, the height and/or length dimensions of which may or may not be identical.

As shown by the figures, the depth of glass is not identical here on either side of said at least one raised portion 161, respectively between the depth P in the melting zone 100 and that of the refining zone 200 which may have at least one depth variation.

As indicated above, such a raised portion 161 may have numerous geometric variants as regards its general shape, its dimensions, in particular depending on the configuration of each of the different segments 164, 166 and 168 that form it.

In the embodiments shown by FIGS. 3 to 7, the hybrid furnace 10 advantageously comprises a first neck 160 in which said separation device 170 is arranged.

According to these embodiments, the invention more particularly proposes a hybrid glass-manufacturing furnace 10 for feeding a float unit for floating glass on a bath of molten metal, said hybrid furnace 10 comprising, from upstream to downstream:
a hot-crown melting zone 100 comprising at least some burners 105 that are able to melt a glass batch 104 to obtain a glass bath 106, said melting zone 100 comprising a first convection current C1,
a neck 160, referred to as first neck, which connects said melting zone 100 to a glass refining zone 200 and comprises a “no-return” separation device 170 configured to prevent the molten glass from going back to the melting zone 100;
said glass-refining zone 200 comprising a first refining zone 210 comprising at least one burner 205 and electrodes 230 and a second refining zone 220, said first refining zone 210 being separated from the melting zone 100 by said separation device 170 and from the second refining zone 220 by a wall 240, respectively, wherein the glass is recirculated in the first refining zone 210 on a second convection current C2 and in the second refining zone 220 on a third convection current C3; and
a glass-cooling zone 300 comprising a conditioning tank 310 through which said third convection current C3 flows.

1. A hybrid glass-manufacturing furnace for feeding a float unit for floating glass on a bath of molten metal, said hybrid glass-manufacturing furnace comprising, from upstream to downstream:
a hot-crown melting zone (100) comprising at least some burners that are configured to melt a glass batch to obtain a glass bath, said hot-crown melting zone comprising a first convection current and being delimited by a no-return separation device that is configured to prevent the molten glass from going back into the hot-crown melting zone;
a glass-refining zone comprising a first refining zone comprising at least one burner and electrodes and a second refining zone, said first refining zone being separated from the hot-crown melting zone by said no-return separation device and from the second refining zone by a wall, respectively, wherein the glass is recirculated in the first refining zone on a second convection current and in the second refining zone on a third convection current; and
a glass-cooling zone comprising a conditioning tank through which said third convection current flows.

2. The hybrid glass-manufacturing furnace according to claim 1, wherein the no-return separation device is configured to prevent the glass from going back from the first refining zone to the hot-crown melting zone, as a result of which the first convection current of the hot-crown melting zone is able to be controlled independently of the second convection current of the first refining zone.

3. The hybrid glass-manufacturing furnace according to claim 1, wherein the no-return separation device is configured to limit the amount of glass passing from the hot-crown melting zone to the first refining zone so as to increase the residence time of the glass in the hot-crown melting zone.

4. The hybrid glass-manufacturing furnace according to claim 1, wherein the no-return separation device comprises a first wall, which is configured to prevent the molten glass from going back from the glass-refining zone to the hot-crown melting zone.

5. The hybrid glass-manufacturing furnace according to claim 1, further comprising a first neck, which connects the hot-crown melting zone to the glass-refining zone.

6. The hybrid glass-manufacturing furnace according to claim 5, further comprising means for cooling the glass which are able to cool the glass in the first neck.

7. The hybrid glass-manufacturing furnace according to claim 5, wherein the first neck comprises a bottom, wherein the no-return separation device comprises at least one raised portion of the bottom of said first neck, which raised portion is configured to prevent the molten glass from going back from the glass-refining zone to the hot-crown melting zone.

8. The hybrid glass-manufacturing furnace according to claim 7, wherein said at least one raised portion of the bottom comprises, from upstream to downstream, at least one ascending segment, a top segment and a descending segment.

9. The hybrid glass-manufacturing furnace according to claim 8, wherein_at least one of said ascending segment and descending segment of said at least one raised portion of the bottom is inclined relative to the horizontal and/or comprises a top segment forming a plateau.

10. The hybrid glass-manufacturing furnace according to claim 7, wherein the raised portion has a maximum height that entirely or partially determines a passage section of the molten glass in the first neck.

11. The hybrid glass-manufacturing furnace according to claim 5, wherein the no-return separation device comprises at least one barrier which, extending vertically, is partially submerged in the glass bath flowing through the first neck, from the hot-crown melting zone to the glass refining zone, said barrier being configured to prevent the molten glass from going back from the glass-refining zone to the hot-crown melting zone.

12. The hybrid glass-manufacturing furnace according to claim 11, wherein the barrier is positioned at the upstream end of the first neck.

13. The hybrid glass-manufacturing furnace according to claim 11, wherein the separation device comprises at least one raised portion of the bottom of said first neck, which raised portion is configured to prevent the molten glass from going back from the glass-refining zone to the hot-crown melting zone, and wherein the no-return separation device comprises the barrier and said at least one raised portion of the bottom of the first neck.

14. The hybrid glass-manufacturing furnace according to claim 13, wherein said at least one raised portion of the bottom comprises, from upstream to downstream, at least one ascending segment, a top segment and a descending segment, and wherein the barrier is positioned above the top segment of the raised portion of the bottom of the first neck.

15. The hybrid glass-manufacturing furnace according to claim 11, wherein the barrier is mounted so as to be vertically movable in order to allow adjustment of the submersion depth thereof in the glass bath, in order to vary the passage section of the molten glass on the basis of the adjustment of the depth of said barrier.

16. The hybrid glass-manufacturing furnace according to claim 1, further comprising separation means for separating an atmosphere of the hot-crown melting zone from an atmosphere of the glass-refining zone.

17. The hybrid glass-manufacturing furnace according to claim 1, further comprising blocking means which are configured to retain a layer of glass batch present at the surface of the glass bath in the hot-crown melting zone, said blocking means being arranged at the downstream end of the hot-crown melting zone.

18. The hybrid glass-manufacturing furnace according to claim 17, wherein the hybrid furnace comprises separation means for separating an atmosphere of the hot-crown melting zone from an atmosphere of the glass-refining zone, and wherein the blocking means are formed by the separation means, a free end of which extends at the surface of the bath, or is submerged in the glass bath.

19. The hybrid glass-manufacturing furnace according to claim 17, wherein the hybrid furnace comprises separation means for separating an atmosphere of the hot-crown melting zone from an atmosphere of the glass-refining zone, and wherein the blocking means are separate from said separation means, said blocking means being attached to or remote from the separation means.

20. The hybrid glass-manufacturing furnace according to claim 1, wherein the hybrid glass-manufacturing furnace is configured to feed a float glass unit with a load of greater than or equal to 400 tons per day with a high-quality glass having less than 0.1 bubble per liter.

21. The hybrid glass-manufacturing furnace according to claim 1, wherein the hot-crown melting zone comprises electrodes which are submerged in the glass bath and which constitute supplementary electrical heating means.

22. The hybrid glass-manufacturing furnace according to claim 21, wherein the electrodes are arranged in a downstream part of the hot-crown melting zone.

23. The hybrid glass-manufacturing furnace according to claim 21, wherein the electrodes of the hot-crown melting zone are selectively controlled to control the first convection current in the hot-crown melting zone.

24. The hybrid glass-manufacturing furnace according to claim 1, wherein the electrodes and said at least one burner of the first refining zone are able to heat the glass to a temperature of greater than 1450° C.

25. The hybrid glass-manufacturing furnace according to claim 1, wherein said at least one burner is arranged in the glass-refining zone to obtain a hot spot at the surface that determines an inversion zone between the second convection current and the third convection current.

26. The hybrid glass-manufacturing furnace according to claim 1, wherein the electrodes of the first refining zone are selectively controlled to control the second convection current in the first refining zone.

27. The hybrid glass-manufacturing furnace according to claim 1, wherein the wall is configured to prevent the glass from going back from the second refining zone to the first refining zone, as a result of which the second convection current of the first refining zone is able to be controlled independently of the third convection current.

28. The hybrid glass-manufacturing furnace according to claim 1, wherein the wall is configured to limit the amount of glass passing from the first refining zone to the second refining zone so as to increase the residence time of the glass in the first refining zone.

29. The hybrid glass-manufacturing furnace according to claim 1, wherein the second refining zone comprises electrodes which are submerged in the glass and which are able to be selectively controlled to control the third convection current.

30. The hybrid glass-manufacturing furnace according to claim 1, wherein the conditioning tank of the cooling zone comprises, from upstream to downstream, a neck, referred to as second neck, then a conditioner.
